(19) United States
(12) Patent Application Publication
(10) Pub. No.: US 2008/0222319 A1
(43) Pub. Date: Sep. 11, 2008

(54) APPARATUS, METHOD, AND PROGRAM FOR OUTPUTTING INFORMATION

(75) Inventors: Yoshinori SATO, Sagamihara (JP); Akihiko Kawasaki, Yamato (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/928,613

(22) Filed: Oct. 30, 2007

(30) Foreign Application Priority Data
Mar. 5, 2007 (JP) 2007-054024

(51) Int. Cl. G06F 13/14

(52) U.S. Cl. 710/34

(57) ABSTRACT

A technique of protection of personal data is provided, in which there is no need to repeatedly instruct search conditions, and also provided is a technique of protection of personal data in which operation cost can be reduced. Respective personal data include multiple items and an item value of each of the items. A information processing apparatus selects at least one of the items for each of multiple personal data. The information processing apparatus counts, for each of the multiple personal data, the number of personal data that include a combination of the same item values as an item value of the selected item. As a result, the information processing apparatus outputs only item values of items having the number of personal data equal to or larger than a threshold, to an output device.

The present application claims a priority from Japanese application no. 2007-054024 filed on Mar. 5, 2007, the content of which is hereby incorporated by reference into this application.

### BACKGROUND OF THE INVENTION

The present invention relates to protection of personal data.

Recently, amid the increasing social demands for protection of privacy, consideration for privacy has become indispensable in data systems of companies that handle personal data. Although objects that should be protected and methods of the protection have not been decided as a socially-accepted idea, for companies (personal data handling operators), it is essential to observe at least the Act on the Protection of Personal Information (hereinafter referred to as Protection Act) which came into force in April 2005, and ordinances related thereto. The Protection Act obliges companies to take measures necessary for personal data management such as collection and use of personal data. Further, more specific measures are prescribed by Ministry and Agency guidelines.

One of the management measures prescribed by the guidelines is to anonymize personal data. For example, the Ministry of Health, Labour, and Welfare requires that medical data (personal data) be anonymized when provided to third parties, announcements in academic meetings, reports on malpractice, and the like, unless it is specifically necessary to disclose the medical data. The Ministry of Economy, Trade, and Industry cites, as desirable measures in providing third parties with personal data, the anonymizing of personal data as well as the acquiring of consent and opting-out policy.

The simpliest processing for anonymizing personal data is to remove individually identifiable data from the personal data or to make the individually identifiable data vague. An example of the former processing is removal of name and address. An example of the latter processing is the conversion of an address in prefecture units and conversion of age at in ten year units.

However, even if such kinds of processing are performed, it is likely that, by collating personal data with data concerning individuals that can be acquired otherwise, a specific individual can be identified from the anonymized personal data. Therefore, in anonymizing personal data, it is desirable to ensure the safety of personal data from the viewpoint of identifiability and the like.

Techniques concerning protection of personal data are disclosed in Japanese Patent Laid-open Publication No. 2004-318391 (hereinafter referred to as Patent Document 1) and Japanese Patent Laid-open Publication No. 2004-287846 (hereinafter referred to as Patent Document 2).

In the technique disclosed in Patent Document 1, when an individual identifiable search condition is included in search conditions for personal data, deletion, change, or the like of the search condition is performed. When individually identifiable data is included in a search result of personal data, the data is removed or the search result is not transmitted.

In the technique disclosed in Patent Document 2, frequencies are set for each item of personal data in advance and, when the personal data is requested, identifiability of an individual related to the personal data is calculated from requested items. When the identifiability is larger than a threshold, a value of any one of the items is not displayed.

In the technique disclosed in Patent Document 1, it is necessary to register individually identifiable data which should be removed from a search result, in a rule storing unit in advance. Therefore, when there is a large quantity of personal data to be protected and the personal data include various data, and when frequency of update of a database for storing personal data is high, the cost for establishing and maintaining the rule storing unit increases. Patent Document 1 does not clearly disclose a method of quantitatively choosing data that should be registered in the rule storing unit.

In the technique disclosed in Patent Document 2, individual identifiability is calculated for each designated item on the basis of frequency of identical data content. For data having multiple items, individual identifiability is calculated from a product of frequencies. However, in the technique disclosed in Patent Document 2, it is likely that the individual identifiability will be estimated lower than an actual degree. Specifically, for example, frequencies as values of respective items are large, and frequency as a combination of the values of the items may be small. In such cases, in the technique disclosed in Patent Document 2, it is likely that data that should not be displayed is displayed.

### SUMMARY OF THE INVENTION

It is an object of the present invention to appropriately protect personal data while reducing operation cost.

According to the present invention, there is provided a information output apparatus including:

a personal data storing unit which stores multiple personal data including multiple items;

a count unit which selects at least one of the multiple items for each of the multiple personal data and counts a number of personal data including the same item values as an item value of the selected item;

a judging unit which judges whether the number of personal data is equal to or larger than a threshold; and

a result output unit which outputs, when it is judged that the number of personal data is equal to or larger than the threshold, only the item value of the selected item to a output device.

In addition, the information output apparatus includes a condition output unit which further outputs, for each of the multiple items, multiple conditions covering different item values to the output device, in which:

the count unit selects one or more of the multiple items for each of the multiple personal data and counts, in accordance with an inputted condition among the outputted conditions, a number of personal data including a combination of item values to be treated as the same item values as the item value of the selected item; and

the result output unit outputs, when the number of personal data is equal to or larger than the threshold, an item value of the selected item to the data output apparatus under the inputted condition.

According to the technique of the present invention, it is possible to appropriately protect personal data while reducing operation cost.

### BRIEF DESCRIPTION OF THE DRAWINGS

In the accompanying drawings:

FIG. 1 is a diagram showing an example of the structure of a computer according to a first embodiment of the present invention;

FIG. 2 is a diagram showing an example of a personal data table according to the embodiment;

FIG. 3 is a diagram showing an example of display item data according to the embodiment;

FIG. 4 is a diagram showing an example of minimum frequency of same data according to the embodiment;

FIGS. 5A to 5C are diagrams showing an example of analysis result data according to the embodiment;

FIG. 6 is a diagram showing an example of output data according to the embodiment;

FIG. 7 is a flowchart showing an example of an operation according to the embodiment;

FIG. 8 is a diagram showing an example of a personal data table for work according to the embodiment;

FIG. 9 is a diagram showing an example of a screen according to the embodiment;

FIG. 10 is a flowchart showing an example of an operation according to the embodiment;

FIG. 11 is a flowchart showing an example of an operation according to the embodiment;

FIG. 12 is a flowchart showing an example of an operation according to the embodiment;

FIG. 13 is a diagram showing an example of the structure of a computer according to a second embodiment of the present invention;

FIG. 14 is a diagram showing an example of option data according to the embodiment;

FIG. 15 is a diagram showing an example of option data according to the embodiment;

FIG. 16 is a diagram showing an example of option data according to the embodiment;

FIGS. 17A and 17b are diagrams showing examples of a screen according the embodiment;

FIG. 18 is a flowchart showing an example of an operation according to the embodiment;

FIG. 19 is a diagram showing an example of output data for work according to the embodiment; and

FIG. 20 is a diagram showing an example of a screen according to the embodiment.

### DESCRIPTION OF THE PREFERRED EMBODIMENTS

Embodiments of the present invention will be hereinafter explained in detail with reference to the accompanying drawings.

The embodiments explained below are mainly of techniques which protect personal data of an electronic form. The “personal data” in the embodiments is data concerning an individual. With the personal data, a specific individual can be identified according to a name, a date of birth, and other data. The personal data includes data which can be easily collated with the other data, and can identify the specific individual. The “data concerning an individual” is not limited to data which is used for identifying an individual such as a name, a sex, and a date of birth, and includes all data representing fact, judgment, evaluation, and the like for each of attributes such as a body, assets, an occupation, and a title of the individual. The data also includes evaluation data, data published by a publication and the like, data in forms of a video (an image) and sound. The data may be encrypted or may not be encrypted. In the embodiments, data entity means a specific individual identified by the personal data. Anonymization of the personal data is processing which converts the personal data to make it impossible to identify the data entity.

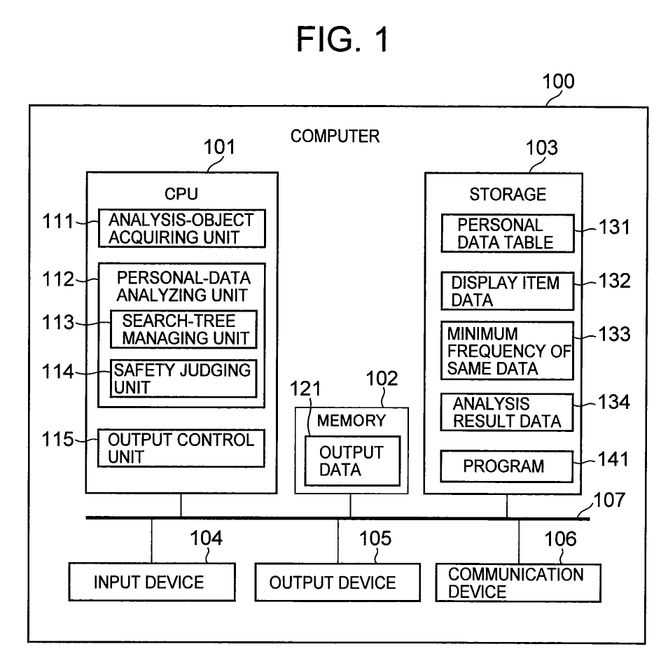

An example of the configuration of an apparatus according to a first embodiment of the present invention is explained with reference to FIG. 1.

In FIG. 1, a computer 100 is an arbitrary data processing apparatus such as a personal computer(PC), a server, or a workstation. The computer 100 includes a central processing unit (CPU) 101, a memory 102, a storage 103, an input device 104, an output device 105, and a communication device 106. The CPU 101, the memory 102, the storage 103, the input device 104, the output device 105, the communication device 106, and the like are connected to one another by a bus 107.

The memory 102 has output data 121. The output data 121 includes data which displays a result obtained by anonymizing personal data described later. Details of this data are described later.

The storage 103 is a storage medium such as a compact disc-recordable (CD-R), a digital versatile disk-random access memory (DVD-RAM), or a silicon disk, a driving device for the storage medium, an hard disk drive (HDD), or the like. The storage 103 stores a personal data table 131, display item data 132, minimum frequency of same data 133, analysis result data 134, a program 141, and the like. The personal data table 131 stores personal data of multiple data entities. In this embodiment, the respective personal data include an item value for each of multiple items. The display item data 132 stores items to be displayed among items of personal data. The minimum frequency of same data 133 stores a threshold. The analysis result data 134 stores an analysis result acquired by an operation described later. Details of those kinds of data are described later. The program 141 is a program which realizes functions described later.

The input device 104 is, for example, a keyboard, a mouse, a scanner, or a microphone. The output device 105 is, for example, a display, a printer, or a speaker. The communication device 106 is, for example, a local area network (LAN) board and is connected to a communication network (not shown).

The CPU 101 executes the program 141 loaded to the memory 102 to thereby realize an analysis-object acquiring unit 111, a personal-data analyzing unit 112, an output control unit 115, and the like.

The analysis-object acquiring unit 111 acquires parameters such as an item as an analysis object and a threshold. The personal-data analyzing unit 112 includes a search-tree managing unit 113 and a safety judging unit 114. The search-tree managing unit 113 and the safety judging unit 114 in the personal-data analyzing unit 112 select at least one item among items in the display item data 132 that should be displayed, acquire the number of personal data having the same item values of the selected item with reference to the personal data stored in the personal data table 131, compare the acquired number with a threshold to thereby judge whether all item values of the items that should be displayed can be displayed, and output a result of the judgment to the analysis result data 134. The output control unit 115 generates the output data 121 with reference to the analysis result data 134 or the like and outputs only an item value of an item that can be displayed.

Detailed examples of the table and the like described above are explained.

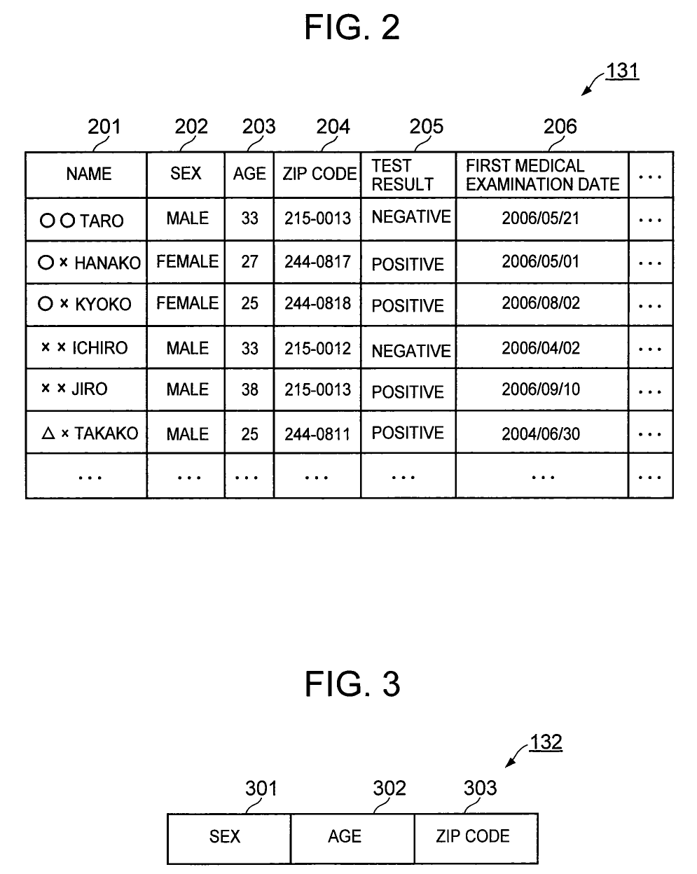

First, an example of the personal data table 131 is explained with reference to FIG. 2.

In FIG. 2, the personal data table 131 has multiple records. One record represents personal data of one data entity. The respective records include item values of items 201 to 206.

The item 201 is a name of the data entity. The item 202 is a sex of the data entity in the same record. The item 203 is an age of the data entity in the same record. The item 204 is a zip code of the data entity in the same record. The item 205 is a test result of the data entity in the same record. The item 206 is a first medical examination date of the data entity in the same record.

Items of the personal data are not limited to those shown in FIG. 2 and may be arbitrary. The number of items of respective data entities is not limited to that shown in FIG. 2 and may be arbitrary.

It is assumed that the data in the personal data table 131 is stored in advance.

An example of the display item data 132 is explained with reference to FIG. 3.

In FIG. 3, the display item data 132 includes items 301 to 303.

The items in the display item data 132 are items desired to be disclosed among the items 201 to 206 in the personal data table 131.

The computer 100 according to this embodiment anonymizes data-entity identifiable data. Therefore, when a data-entity identifiable item is included in the display item data 132, the function of the computer 100 is particularly effective. The data-entity identifiable item is not limited to an item with which the data entity can be directly identified such as a name. It is likely that the data entity can be identified with a sex, an age, a zip code (or an address), or the like by referring to general directory data or the like.

Items in the display item data 132 may be arbitrary. For example, a test result, a first medical examination date, and the like may be included in the display item data 132. A system user judges items in the display item data 132 according to a threat of individual identification assumed in operation of a system. Criteria of the judgment is, for example, who is a data user that can refer to personal data anonymized and disclosed and whether it is a problem in protection of privacy if it is possible to identify the data entity with the anonymized personal data by collating a fact that the data user knows and the test result, the first medical examination date, and the like.

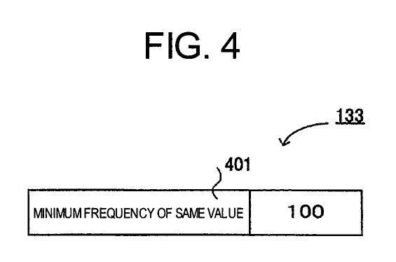

An example of the minimum frequency of same data 133 is explained with reference to FIG. 4.

In FIG. 4, the minimum frequency of same data 133 has a minimum frequency of same value 401. The minimum frequency of same value 401 is a value indicating that, if the number of records having the same item number is equal to or larger than the minimum frequency of same value 401, it can be regarded as difficult to identify the data entity even if the personal data is disclosed. In the case of the example in FIG. 4, since the minimum frequency of same value 401 is “100”, this indicates that, if the number of records having the same item value is equal to or larger than “100”, it can be regarded as safe even if the personal data is disclosed. In this embodiment, an allowable probability of identification is set to be equal to or smaller than “1/K (minimum frequency of same value)”.

A value of the minimum frequency of same value is not specifically limited and may be arbitrary.

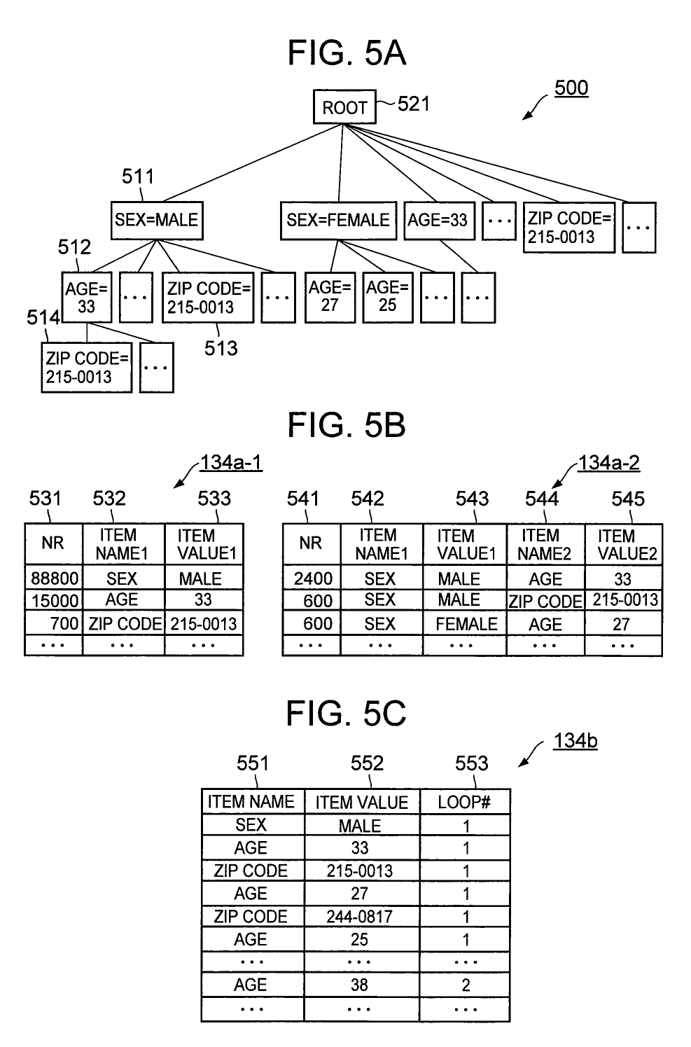

An example of the analysis result data 134 is explained with reference to FIG. 5.

As described above, the computer 100 selects one or more items among items in the display item data 132 that should be displayed, acquires the number of personal data having the same item values of the selected items with reference to the personal data stored in the personal data table 131, and compares the acquired number with the minimum frequency of same value to thereby judge whether item values of the items that should be displayed can be displayed. First, the search for a combination of displayable item values is explained with reference to a schematic diagram of FIG. 5A.

In FIG. 5A, a search tree 500 has multiple nodes. The respective notes indicate combinations of item values in a parent and child relation. For example, a node 511 indicates a combination of item values “sex=male”. A node 512 indicates a combination of item values “sex=male” and “age=33”. A node 53 indicates a combination of item values “sex=male” and “zip code=215-0013”. A node 514 indicates a combination of item values “sex=male”, “age=33”, and “zip code=215-0013”. A root node 521 is a node for management of the search tree 500.

In the following explanation, the number of arcs present between a certain node and the root node is referred to as the depth of the node. The depth of the root node is set to “zero”. Each of one or more nodes present on a path between a certain node (hereinafter referred to as object node) and the root node is referred to as ancestor node of the object node. Specifically, for example, in the case of the search tree 500 of FIG. 5A, when the node 512 is an object node, an ancestor node is the node 511. Among ancestor nodes of an object node, an ancestor node above and adjacent to this object node, i.e., an ancestor node that has the depth “Z−1” when the depth of the object node is “Z”, is referred to as a parent node of the object node. In a search tree, the number of parent nodes of each of all nodes excluding a root node is “1”. Specifically, for example, in the case of the search tree 500 of FIG. 5A, when the node 512 is an object node, a parent node is the node 511. A node below and adjacent to an object node is referred to as a child node of the object node. In the search tree, the number of child nodes of each of all the nodes is “equal to or larger than zero”. Specifically, for example, in the case of the search tree 500 of FIG. 5A, when the node 512 is an object node, the node 514 is a child node. Nodes below an object node are referred to as descendent nodes of the object node. In the search tree, the number of descendent nodes of each of all the nodes is “equal to or larger than zero”. Specifically, for example, in the case of the search tree 500 of FIG. 5A, when the node 511 is an object node, descendent nodes are the nodes 512, 513, 514, and the like. When there are other nodes that have a parent node common to an object node, the nodes are referred to as brother nodes. For example, in the case of the search tree 500 of FIG. 5A, when the node 512 is an object node, the brother nodes are the node 513 and the like. A node that does not have a child node is referred to as leaf node.

In the following explanation, processing which calculates the number of records that have a combination of item values represented by nodes is referred to as node evaluation processing. A node the number of records of which calculated by the node evaluation processing is equal to or larger than the minimum frequency of same value is referred to as a “safe node”, and a node the number of records of which is smaller than the minimum frequency of same value is referred to as an “unsafe node”. A combination of item values at the time when the number of records calculated by the node evaluation processing is equal to or larger than the minimum frequency of same value is referred to as a “safe item value set”, and a combination of item values at the time when the number of records is smaller than the minimum frequency of same value is referred to as an “unsafe item value set”.

An example of the analysis result data 134 is explained with reference to FIGS. 5B-1, 5B-2, and 5C.

The analysis result data 134 has multiple tables. The tables include separate tables for each number of combinations of items stored in the display item data 132 and tables in which data in the case of the safe item value set among the respective item values of combinations of the items are stored. In order to distinguish the tables from one another, reference symbols are affixed to the tables in such a manner as an “analysis result data table 134-a1” and an “analysis result data table 134-b”.

An example of the separate tables for each number of combinations of items stored in the display item data 132 is explained with reference to FIGS. 5B-1 and 5B-2.

In FIG. 5B-1, the analysis result data table 134-a1 is an example of a table in which the number of combinations of items is “1”. Respective records of the analysis result data table 134-a1 have fields 531, 532, and 533. The field 532 is for an item name of a node. The field 533 is for an item value of the item name in the field 532 corresponding thereto. The field 531 indicates the number of records, which are the item name of the node and the item value of the node shown in the field 532 and the field 533 corresponding thereto, respectively.

In FIG. 5B-2, an analysis result data table 134-a2 is an example of a table in which the number of combinations of items is “2”. Respective records of the analysis result data table 134-a2 have fields 541, 542, 543, 544, and 545. The field 542 is for an item name of a node. The field 543 is for an item value of the item name of the field 542 corresponding thereto. The field 544 is for an item name of a node. The field 545 is an item value of the item name of the field 544 corresponding thereto. The field 541 indicates the number of records, which are the item names of the nodes and the item values of the nodes shown in the fields 542, 543, 544, and 545 corresponding thereto, respectively.

In FIGS. 5B-1, and 5B-2, only the examples of the analysis result data table 134-a1 and the analysis result data table 134-a2 are shown. However, the analysis result data 134 has the number of tables, the examples of which are shown in FIGS. 5B-1, and 5B-2, equivalent to the depth of the search tree, the example of which is shown in FIG. 5A. When these table are collectively explained below, the tables are referred to as an analysis result data table 134-a.

An example of a table that stores data in the case of the safe item value set among the item values of combinations of items is explained with reference to FIG. 5C.

In FIG. 5C, respective records of the analysis result data table 134-b have fields 551, 552, and 553. The field 551 and the field 552 are for the item name and the item value, respectively, stored in the analysis result data table 134-a. The field 553 is a loop number at the time when a safe node is detected in processing described later.

In the examples in FIGS. 5B-1, 5B-2 and 5C, the item names in the fields 532, 542, 544, and 551 are directly shown. However, on an actual program, the respective item names are indicated by continuous numerical values equal to or larger than 0. Specifically, for example, item names “sex”, “age”, and “zip code” are indicated by “0”, “1”, and “2”, respectively. In the examples of FIGS. 5B-1, 5B-2, and 5C, the item values in the fields 533, 543, 545, and 552 are directly shown. However, on the actual program, the item values of the respective item names are indicated by continuous numerical values equal to or larger than zero. Specifically, for example, item values “male” and “female” of the item name “sex” are indicated by “0” and “1”, respectively. For example, item values “33”, “27”, “25”, “38”, and the like of the item name “age” are indicated by “0”, “1”, “2”, “3”, and the like, respectively. Item values “215-0013”, “244-0817”, “244-0818”, and the like of the item name “zip code” are indicated by “0”, “1”, “2”, and the like, respectively.

In the following explanation, for convenience of explanation, the item names and the item values are explained as the original item names and item values instead of the integers described above. However, even in this case, when the function of the computer 100 is processed as the program executed by the computer 100, the item names and the item values are treated as integers, respectively. In the following explanation, an integer indicating an item name is also referred to as an item number, and an integer indicating an item value is also referred to as an item value number.

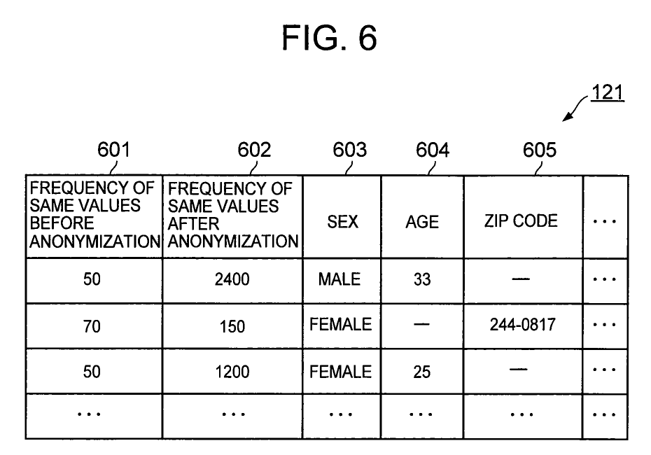

An example of the output data 121 is explained with reference to FIG. 6.

The output data 121 includes multiple records. The respective records include a frequency of same values before anonymization 601, a frequency of same values after anonymization 602, and item values of items 603 to 605. The frequency of same values before anonymization 601 is the number of records in the personal data table 131 that have item values same as item values included in the same records. The frequency of same values after anonymization 602 is the number of records in the personal data table 131 that have, when one or more item values of item values included in the same records are anonymized, item values same as the remaining item values. In the example of FIG. 6, item values “−” of items 604 and 605 indicate that the item values are anonymous. Specifically, for example, in the case of the example of FIG. 6, a record 611 indicates that, in the personal data table 131, as indicated by the frequency of same values before anonymization 601, there are “50” records in which the item 603 is “male”, the item 604 is “33”, and the item 605 is “—(anonymous)”. In the case of the example of FIG. 6, the record 611 indicates that, in the personal data table 131, as indicated by the frequency of same value after anonymization 602, there are “2400” records in which item values of the item 603 and the item 604 are “male” and “33”, respectively.

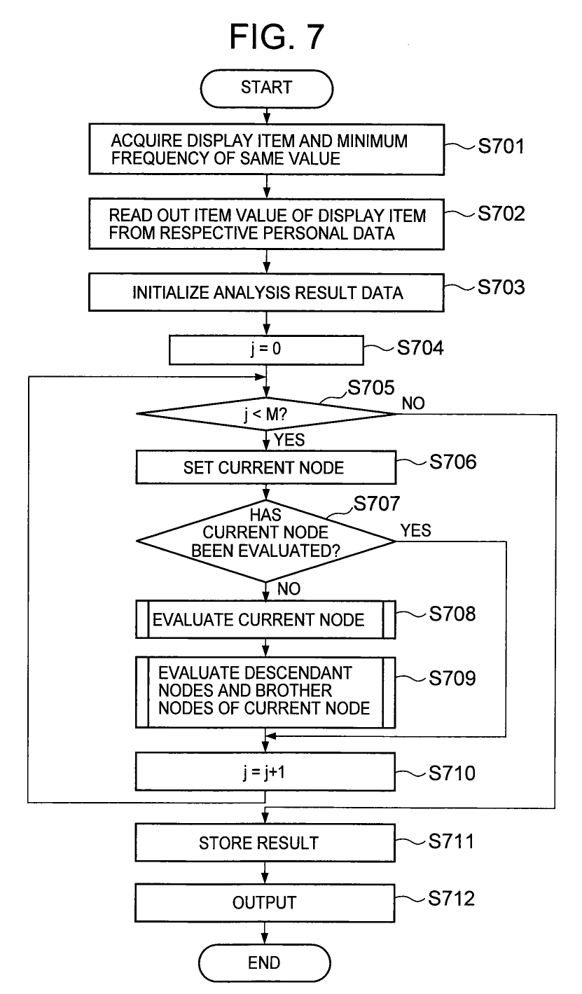

An example of an operation of the computer 100 is explained with referenced to FIG. 7.

First, the analysis-object acquiring unit 111 acquires the display item data 132 and the minimum frequency of same data 133 (S701). The display item data 132 and the minimum frequency of same data 133 may be stored in the storage 103 in advance or may be inputted via the input device 104, the communication device 106, or the like.

The personal-data analyzing unit 112 reads record data including items designated in the display item data 132 into the memory 102 with reference to the personal data table 131 (S702). Specifically, for example, the personal-data analyzing unit 112 selects items coinciding with the items 301 to 303 in the display item data 132 out of the items 201 to 206 in the personal data table 131. The personal-data analyzing unit 112 reads out item values of the selected items in the respective records and reads the item values into the memory 102. In the case of the examples of the personal data table 131 and the display item data 132 shown in FIGS. 2 and 3, the display item data 132 has the item 301 “sex”, the item 302 “age”, and the item 303 “zip code”. Therefore, the personal-data analyzing unit 112 selects the item 202 “sex”, the item 203 “age”, and the item 204 “zip code” from the personal data table 131. The personal-data analyzing unit 112 extracts item values of the selected items 202 to 204 in the respective records in the personal data table 131 and stores the item values in the memory 102.

In the processing in Step S702, as described above, the items and the item values are converted into integers and stored in the memory 102.

In the following explanation, when a table stored in the memory 102 in the processing in Step S702 is specifically distinguished, the table is referred to as a “personal data table 131′”. The personal data table 131′ is a table for work.

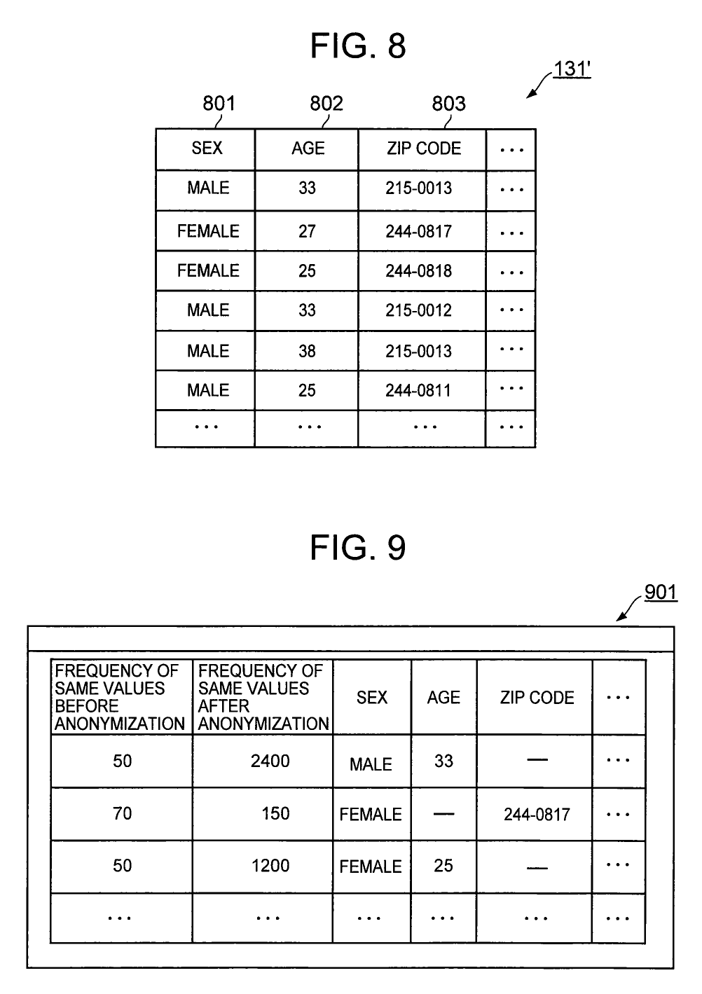

In the case of the examples of the personal data table 131 and the display item data 132 shown in FIGS. 2 and 3, an example of the personal data table 131′ stored in the memory 102 in the processing in Step S702 is shown in FIG. 8. In FIG. 8, the personal data table 131′ has multiple records. The respective records have item values of items 801 to 803. The item values of the items 801 to 803 of the respective records are the same as the item values of the items 202 to 204 of the respective records in the personal data table 131.

In the following explanation, a “j”th item value of an “i”th record in the personal data table 131′ is represented as “D[i] [j]”. Here, [i] is an integer equal to or larger than “zero” and equal to or smaller than “N−1” and “j” is an integer equal to or larger than “zero” and equal to or smaller than “M−1”. “N” is the number of records in the personal data table 131′. “M” is the number of items in the personal data table 131′ (or the display item data 132).

In FIG. 7, the search-tree managing unit 113 initializes the analysis result data 134 (S703). Therefore, the search-tree managing unit 113 initializes table structures of respective tables of the analysis result data 134. Specifically, for example, the search-tree managing unit 113 establishes “M” analysis result data tables 134-a and empties respective records in these tables. These tables are the analysis result data table 134-a1, the analysis result data table 134-a2, and the like.

In steps after Step S703, the search-tree managing unit 113 evaluates nodes of a search tree in order. Details of this evaluation processing are explained below. In the following explanation, first, rules of the evaluation are explained.

A rule (1) is that a root node is set as an origin.

A rule (2) is that, when both a child node and a brother node as processing objects are present at a point when the evaluation of a certain node is finished, the child node is evaluated first.

However, when multiple child nodes are present, evaluation priority conforms to the following rules.

A rule (2-1) is that child nodes having smaller integers (item numbers) among integers indicating item names are evaluated earlier.

A rule (2-2) is that, when two or more child nodes having the same item name are present, child nodes having smaller integers (item value numbers) indicating item values of the child nodes are evaluated earlier.

When multiple brother nodes are present, evaluation priority conforms to the following rules.

A rule (2-3) is that brother nodes having smaller integers (item numbers) among integers indicating item names of the multiple brother nodes are evaluated earlier.

A rule (2-4) is that, when two or more brother nodes having the same item name are present, brother nodes having smaller integers (item value numbers) among integers indicating item values of the two or more brother nodes are evaluated earlier.

After the processing in Step S703, the search-tree managing unit 113 initializes a loop variable “j” representing an item number (S704). Specifically, the search-tree managing unit 113 sets “j” to “0”.

The safety judging unit 114 judges whether “j” is smaller than “M” (S705). As described above, “M” is the number of items in the personal data table 131′.

When “j” is smaller than “M” as a result of the judgment in Step S705, the safety judging unit 114 sets a current node (S706). Specifically, for example, the safety judging unit 114 sets the variable “j” indicating an item number and the item value number “0” of this item to a variable “P” indicating the current node. For example, in the case of the C language, the variable “P” is defined by a structure as “P. FIELD=j” and “P.VALUE=0”. The item number is stored in “P.FIELD” and the item value number is stored in “P.VALUE”. Specifically, for example, in the case of “j=0”, i.e., the item “sex”, an item value of this item name is “male” or “female”. Therefore, when the item value is “male”, “P.VALUE=0” is stored and when the item value is “female”, “P.VALUE=1” is stored.

The safety judging unit 114 judges whether the item value of the current node has been evaluated (S707). Specifically, for example, the safety judging unit 114 judges whether there is an item, a value in the field 553 of which is smaller than the variable “j” and a value in the field 552 of which coincides with the value of the variable “P.VALUE”, with reference to the table that stores data in the case of the safe item value set in the analysis result data 134, i.e., the analysis result data table 134-b.

When the item value of the current node has been evaluated as a result of the judgment in Step S707, the safety judging unit 114 shifts to processing in Step S710 described later.

When the item value of the current node has not been evaluated as a result of the judgment in Step S707, the safety judging unit 114 evaluates the current node (S708). Details of the processing are explained later.

The safety judging unit 114 evaluates descendant and brother nodes of the current node (S709). In the judgment of the brother nodes, the safety judging unit 114 sets nodes, item names with the depth of a search tree “1” of which are indicated by the integer “j”, as evaluation objects and also evaluates all descendant nodes of the respective brother nodes. Details of the processing are explained later.

The safety judging unit 114 increments “j” by 1 to “j+1” (S710) and performs the processing in Step S705 and the subsequent steps again.

On the other hand, when “j” is not smaller than “M” as a result of the judgment in Step S705, the output control unit 115 stores the analysis result data 134 on the memory 102 in the storage 103 (S711). Specifically, the output control unit 115 stores the analysis result data table 134-a in the storage 103. The output control unit 115 creates the output data 121 from the analysis result data 134, the personal data table 131, and the like and outputs the output data 121 to the output device 105, the communication device 106, or the like (S712). Details of the processing are explained later.

An example of a screen which displays data in the output data 121 on the display of the output device 105 or the like is shown in FIG. 9. In FIG. 9, a screen 901 is an example of a screen displayed in the case of the output data 121, the example of which is shown in FIG. 6.

As shown on the screen 901 in FIG. 9 as an example, item values, identification probabilities of which are larger than “1/K”, are eliminated and only item values judged as being allowed to be disclosed are displayed or otherwise outputted in the processing described above.

Timing which performs the output processing in Step S712 is arbitrary. The output processing does not have to be performed immediately after the processing in Steps S701 to S711. For example, the output processing may be performed at every predetermined time or when an output instruction is inputted from the input device 104.

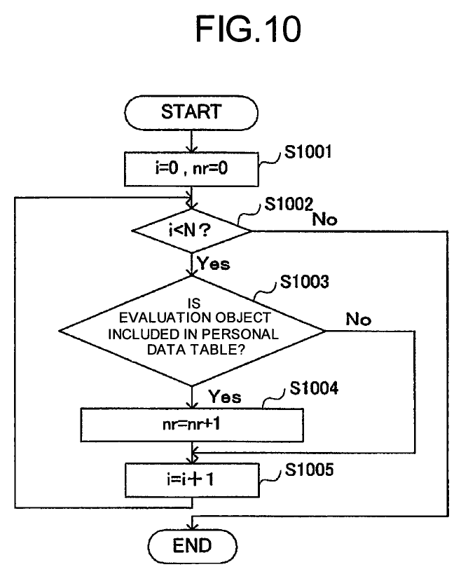

An example of the operation which evaluates the current node in Step S708 described above is explained in detail with reference to FIG. 10.

First, the safety judging unit 114 initializes a loop variable “i” indicating the current node and a variable “nr” indicating the number of records, which are item names of processing object nodes and item values of the processing object nodes (S1001). Specifically, the safety judging unit 114 sets the loop variable “i” to “0” and sets the variable “nr” to “0”. The safety judging unit 114 judges whether “i” is smaller than “N” (S1002). As described above, “N” is the number of records in the personal data table 131′.

When “i” is smaller than “N” as a result of the judgment in Step S1002, the safety judging unit 114 judges whether an item and an item value as evaluation objects are included in an “i”th record in the personal data table 131′ (S1003). Therefore, the safety judging unit 114 judges whether, for example, an item value of an item with an item number “P.FIELD” of the “i”th record in the personal data table 131′, i.e., a value of “D[i] [P.FIELD]”, coincides with “P.VALUE”.

When the item and the item value as processing objects are not included as a result of the judgment in Step S1003, the safety judging unit 114 performs processing in Step S1005 and the subsequent steps described later.

When the item and the item value as processing objects are included as a result of the judgment in Step S1003, the safety judging unit 114 increments “nr” by 1 to “nr+1” (S1004) and increments “i” by 1 to “i+1” (S1005). The safety judging unit 114 performs the processing in Step S1002 and the subsequent steps again.

On the other hand, when “i” is not smaller than “N” as a result of the judgment in Step S1002, the safety judging unit 114 finishes the processing in Step S708 and performs the processing in Step S709 and the subsequent steps.

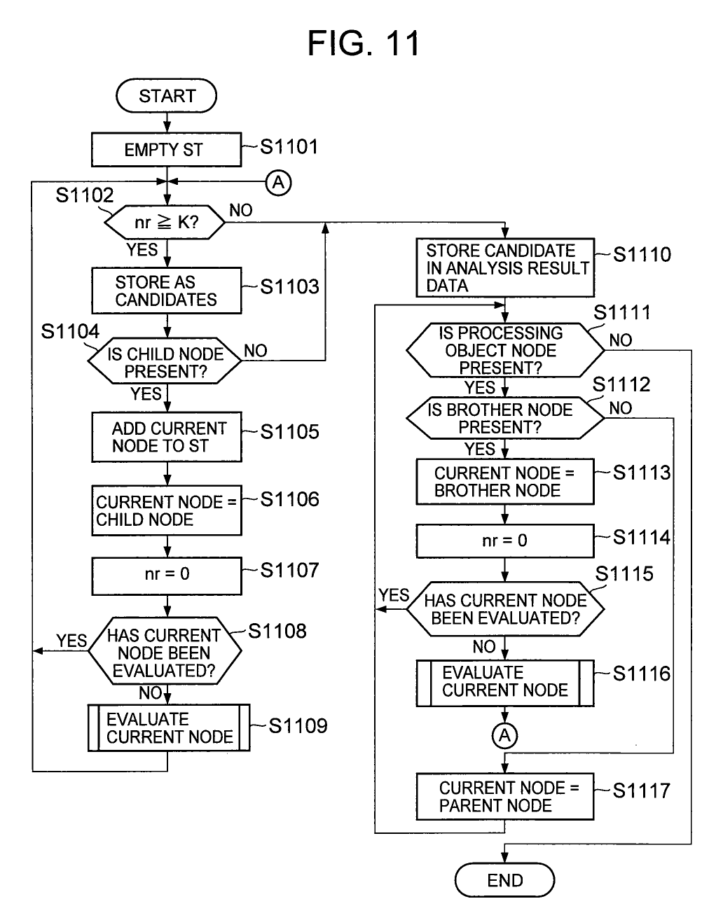

Details of an example of the operation which evaluates the descendant and brother nodes of the current node in Step S709 are explained with reference to FIG. 11.

The safety judging unit 114 initializes a variable “ST” indicating a set of ancestor nodes of nodes as processing objects (S1101). The variable “ST” is a stack variable and stored in an area generally called a first in last out (FILO) buffer. In this embodiment, in respective elements of the variable “ST”, values of the variable “P” are stored. The safety judging unit 114 extracts all elements stored in the variable “ST” and empties the stack.

The safety judging unit 114 judges whether “nr” is equal to or larger than “K” (S1102). “nr” is a value of the current node acquired in the processing in Step S708.

When “nr” is not equal to or larger than “K” as a result of the judgment in Step S1102, the safety judging unit 114 performs processing in Step S1110 and the subsequent steps described later.

When “nr” is equal to or larger than “K” as a result of the judgment in Step S1102, the safety judging unit 114 temporarily stores an item and an item value judged in the present processing and the number of records of the item and the item value as candidates of a safe item value set (S1103). Therefore, for example, the safety judging unit 114 sets values of the variable “ST” and the variable “nr” as values of a variable “ST” and a variable “mm”, respectively.

The safety judging unit 114 judges whether a child node of the current node is present (S1104). Therefore, the safety judging unit 114 judges whether “P.FIELD” is smaller than “M−1”. When “P.FIELD” is not smaller than “M−1” as a result of the judgment, the safety judging unit 114 judges that a child node of the current node is present. When “P.FIELD” is not smaller than “M−1” as a result of the judgment, the safety judging unit 114 judges that a child node of the current node is not present.

When a child node of the current node is not present as a result of the judgment in Step S1104, the safety judging unit 114 performs processing in Step S1110 and the subsequent steps described later.

When a child node of the current node is present as a result of the judgment in Step S1104, the safety judging unit 114 adds a value of the variable “P” to the variable “ST” (S1105). The safety judging unit 114 sets the child node of the current node as a new current node (S1106). Therefore, the safety judging unit 114 increments “P.FIELD” by 1 to “P.FIELD+1” and sets “P.VALUE” to “0”.

The safety judging unit 114 sets “nr” to “0” (S1107) and judges whether an item value of the new current node set in the processing in Step S1106 has been evaluated (S1108). Since this processing is the same as Step S707, explanation of the processing is omitted.

When the item value of the current node has been evaluated as a result of the judgment in Step S1108, the safety judging unit 114 performs the processing in Step S1102 and the subsequent steps again.

When the item value of the current node has not been evaluated as a result of the judgment in Step S1108, the safety judging unit 114 evaluates the item value of the current node (S1109). This evaluation processing is the same as Steps S1001 to S1105 described above except for Step S1003. In the processing in Step S1109, instead of Step S1003 described above, the safety judging unit 114 judges whether all items and item values stored in the variable “P” and the variable “ST” are included in items and item values of the “i”th record in the personal data table 131′. For more specific explanation, a “t”th element of the variable “ST” is indicated by a variable “ST[t]”, an item number of an item of this element is indicated by “ST [t] FIELD”, and an item value number of an item value of this element is indicated by “ST [t] VALUE”. “t” is a value equal to or larger than zero and smaller than the number of elements stored in the variable “ST”. The safety judging unit 114 judges whether “D[i] [P.FIELD]” is equal to “P.VALUE” for each “i” incremented by 1 at a time as described above. The safety judging unit 114 further judges whether “D[i] [ST [t] FIELD]” is equal to “ST[t] VALUE” for each “i” and each “t” incremented by 1 at a time. When “D[i] [P.FIELD]” is equal to “P.VALUE” and “D[i] [ST [t] FIELD]” is equal to “ST[t] VALUE” for the “i”th record in the personal data table 131′ as a result of this judgment, the safety judging unit 114 judges that an item and an item value as evaluation objects are included in the “i”th record in the personal data table 131′.

After the processing in Step S1109, the safety judging unit 114 performs the processing in Step S1102 and the subsequent steps again.

On the other hand, when “nr” is not equal to or larger than “K” as a result of the judgment in Step S1102 and when a child node is not present as a result of the judgment in Step S1104, the safety judging unit 114 stores the candidates of the safe item value set, which are temporarily stored in the processing in Step S1103 as described above, in the analysis result data table 134-a and the analysis result data table 134-b (S1110). Therefore, when the number of elements of the variable “ST′” is “x”, the safety judging unit 114 adds a new record in an “x”th item in the analysis result data table 134-a and stores items and item values of the respective elements of the variable “ST′” and a value of the variable “nr′” as values of respective fields of the record. Moreover, the safety judging unit 114 adds new “x” records in the analysis result data table 134-b and stores items, item values, and the variable “i” in the added records, respectively. In this case, when records having the same items, item values, and the variable “i” are already included in the analysis result data table 134-b, the safety judging unit 114 does not store the values.

Specifically, a case will be described as an example in which {ST′[0].FIELD=sex, ST′[0].VALUE=male} and {ST′[1].FIELD=age, ST′[1].VALUE=33} are stored as elements of the variable “ST′”, “nr′” is “2400”, and “i” is “1”. In this case, the safety judging unit 114 adds a new record in the analysis result data table 134-a2 and stores “2400”, “sex”, “male”, “age”, and “33” as values of the fields 541 to 545 of the added record, respectively. Moreover, the safety judging unit 114 adds two records in the analysis result data table 134-b, stores “sex”, “male”, and “1” as values of the fields 551 to 553 of one of the added records, respectively, and stores “age”, “33”, and “1” as values of the fields 551 to 553 of the other record, respectively.

The safety judging unit 114 judges whether the evaluation of all nodes having the depth “1” of items indicated by the integer “j” and descendant nodes of these nodes has been finished (S111). Therefore, the safety judging unit 114 judges whether a value of the item value number “P.VALUE” coincides with a maximum value that an item value of the item number “P.FIELD” can take. Moreover, the safety judging unit 114 judges whether the value of the item value number “P.VALUE” is included in the variable “ST”. When the value of “P.VALUE” coincides with the maximum value that the item value of “P.FIELD” can take and the value of “P.VALUE” is not included in the variable “ST” as a result of these judgments, the safety judging unit 114 judges that the evaluation of all the nodes having the depth “1” and the descendant nodes of these nodes has been finished.

Specifically, a case will be described as an example in which {ST[0].FIELD=sex, ST[0].VALUE=male} and {ST[1].FIELD=age, ST[1].VALUE=33} are stored as elements of the variable “ST”, and “P.FIELD” is “3” (zip code) and “P.VALUE” is “0” (215-0013)”. In this case, a value of an item value number “P.VALUE=0 (215-0013)” does not coincide with a maximum value of a value that an item number “P.FIELD=3 (zip code)” can take. The value of the item value number “P.VALUE=0 (215-0013)” is not included in the variable “ST”. Therefore, the safety judging unit 114 judges that the evaluation of all the nodes having the depth “1” and the descendant nodes of these nodes has not been finished.

When the evaluation of all the nodes having the depth “1” and the descendant nodes of these nodes has been finished as a result of the judgment in Step S1111, the safety judging unit 114 finishes the processing in Step S709 and performs the processing in Step S710 and the subsequent steps.

When the evaluation of all the nodes having the depth “1” and the descendant nodes of these nodes has not been finished as a result of the judgment in Step S1111, the safety judging unit 114 judges whether a brother node of the current nodes is present (S1112). Therefore, for example, the safety judging unit 114 judges whether the value of the item value number “P.VALUE” is smaller than the maximum value that the item value of the item number “P.FIELD” can take and/or “P.FIELD” is larger than “M”. When the value of the item value number “P.VALUE” is smaller than the maximum value that the item value of the item number “P.FIELD” can take and/or “P.FIELD” is larger than “M” as a result of the judgment, the safety judging unit 114 judges that a brother node of the current node is present. As described above, “M” is the number of items in the personal data table 131′.

When a brother node of the current node is present as a result of the judgment in Step S1112, the safety judging unit 114 sets the brother node as a current node (S1113). Therefore, when the value of the item value number “P.VALUE” is smaller than the maximum value that the item value of the item number “P.FIELD” can take, the safety judging unit 114 increments “P.VALUE” by 1 to “P.VALUE+1”. When the value of the item value number “P.VALUE” is not smaller than the maximum value that the item value of the item number “P.FIELD” can take, the safety judging unit 114 increments “P.FIELD” by 1 to “P.FIELD+1” and sets “P.VALUE” to “0”.

Moreover, the safety judging unit 114 sets the variable “nr” to “0” (S1114). The safety judging unit 114 judges whether an item value of the new current node set in the processing in Step S1113 has been evaluated (S1115). Since this processing is the same as Step S1108, explanation of the processing is omitted.

When the item value of the current node has been evaluated as a result of the judgment in Step S1115, the safety judging unit 114 performs the processing in Step S1111 and the subsequent steps again.

When the item value of the current node has not been evaluated as a result of the judgment in Step S1115, the safety judging unit 114 evaluates the item value of the current node (S1116). Since this evaluation processing is the same as Step S1109, explanation of the processing is omitted.

On the other hand, when a brother node of the current node is not present as a result of the judgment in Step S1112, the safety judging unit 114 sets the current node as a parent node (S1117). Therefore, the safety judging unit 114 extracts an element added last from the variable “ST” and sets the extracted element as a new value of the variable “P”. After this processing, the safety judging unit 114 performs the processing in Step S1111 and the subsequent steps again.

The computer 100 is characterized in that, as described above, rather than it extracts an item value that should be kept secret, a set of item values having low identification probabilities are exhaustively checked and an item value that can be disclosed is extracted. If only a set of item values having identification probabilities equal to or higher than a threshold is disclosed and a set of item values not outputted is not disclosed, it is possible to guarantee an identification probability equal to or lower than “1/K” for all the records in the personal data table 131. The computer 100 discriminates, in the processing in Step S1002, a set of item values not required to be evaluated making use of a characteristic that, as the number of items to be combined increases, the number of records, item values of which coincide with one another, monotonously decreases. In other words, the computer 100 judges whether an identification probability is equal to or higher than the threshold every time the number of items to be combined is increased by one and, at a point when the identification probability is not equal to or higher than the threshold, stops evaluating the items while increasing the number of items. Moreover, the computer 100 judges, in the processing in each of Steps S707, S1108, and S1115, whether the item value of the current node has been evaluated. When the item value of the current node has been evaluated as a result of the judgment, the computer 100 does not perform evaluation of nodes deeper than the current node. This processing is performed making use of the characteristic of the safe item value set and the structure of the search tree. In other words, this processing is performed making use of a characteristic that, when there are two item value sets “α” and “β” and “α” has all item values of “β”, if “α” is a safe item value set, “β” is also a safe item value set. This processing is performed making use of a characteristic that, according to the evaluation rules (1) and (2) of the search tree, in item value sets such as “α” and “β”, nodes corresponding to “α” are evaluated earlier. Consequently, the computer 100 is capable of efficiently executing the processing.

In the processing in each of Steps S707, S1008, and S1115, a processing technique which searches for a record in the analysis result data 134 with values of items and item values as search keys may be arbitrary. For example, the analysis result data 134 may be directly searched for or an index may be established anew by one or more items of the items and the items values and a record may be searched for by using this index. A record search tree equivalent to the search tree may be established on the memory 102 by a hash tree which identifies a node with an item and an item value and a record may be searched for by using this tree.

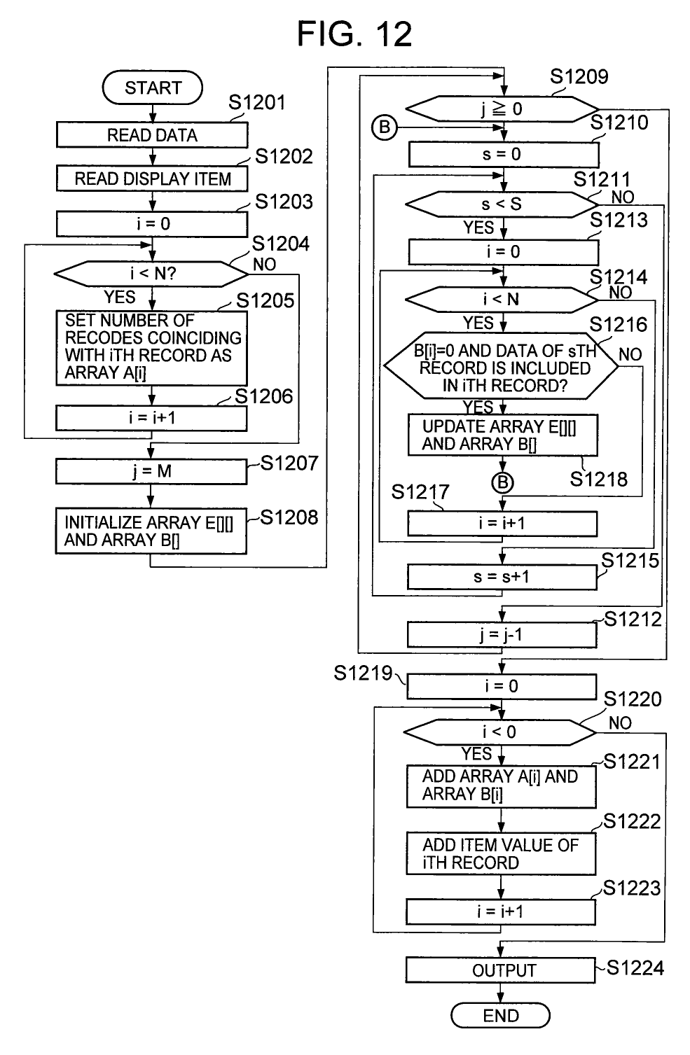

Details of an example of the operation which outputs the result in Step S711 are explained with reference to FIG. 12.

The output control unit 115 reads out the display item data 132, the minimum frequency of same data 133, the analysis result data table 134-a, and the like from the storage 103 (S1201). The personal-data analyzing unit 112 reads record data including items designated in the display item data 132 into the memory 102 with reference to the personal data table 131 (S1202). This processing is the same as Step S702. Consequently, the output control unit 115 stores the personal data table 131′ in the memory 102.

The output control unit 115 initializes the loop variable “i” (S1203). Specifically, the output control unit 115 sets “i” to “0”.

The output control unit 115 judges whether “i” is smaller than “N” (S1204). As described above, “N” is the number of records in the personal data table 131′.

When “i” is smaller than “N” as a result of the judgment in Step S1204, the output control unit 115 counts the number of records, sets of item values of which coincide with that of the “i”th record in the personal data table 131′, and stores the number of records in an “array A[i]” (S1205). In processing described later, the output control unit 115 uses the acquired “array A[i]” as a value of the frequency of same value before anonymization 601 of a record which outputs in the memory 102.

The output control unit 115 increments “i” by 1 to “i+1” (S1206) and performs the processing in Step S1204 and the subsequent steps again.

A record search technique is not specifically limited. For example, as described above, values of items may be directly compared. It is also possible that, in order to increase speed of search processing, first, indices of a hash table or the like are created by coupling values of key items for each of records, and then, the records are compared using the indices.

On the other hand, when “i” is not smaller than “N” as a result of the judgment in Step S1204, the output control unit 115 initializes the loop variable “j” which checks the same item value set of the personal data table 131′ (S1207). Specifically, the output control unit 115 sets “j” to “M”. “j” indicates a “j”th table among multiple analysis result data tables 134-a. As described above, “M” is the number of items in the personal data table 131′.

Subsequently, the output control unit 115 initializes an array “E[ ] [ ]” indicating values of an output judgment table and an array “B[ ]” (S1208). Therefore, the output control unit 115 sets all elements of the array “E [ ] [ ]” and the array “B [ ]” to zero. The array “E [u] [v]” indicating values of the output judgment table indicates, for example, whether item values of items indicated by an integer “v” in a “u”th record in the personal data table 131 are a safe item value set. In other words, when it is judged according to processing described later that the item values of the items indicated by the integer “v” in the “u”th record in the personal data table 131′ are a safe item value set, the value of “E[u] [v]” is changed from “zero” to “1”. The number “nr” of records, which are an item and an item value of the “u”th record in the “j”th analysis result data table 134-a, is stored in the array “B[u]” in processing described later.

The output control unit 115 judges whether “j” is equal to or larger than “0” (S1209).

When “j” is equal to or larger than “0” as a result of the judgment in Step S1209, the output control unit 115 initializes a variable “s” (S1210). Specifically, the output control unit 115 sets “s” to “0”. “s” indicates a record in the “j”th analysis result data table 134-a.

The output control unit 115 judges whether “s” is smaller than “S” (S1211). “S” is the number of records in the “j”th analysis result data table 134-a.

When “s” is not smaller than “S” as a result of the judgment in Step S1211, the output control unit 115 decrements “j” by 1 to “j−1” (S1212) and performs the processing in Step S1209 and the subsequent steps.

When “s” is smaller than “S” as a result of the judgment in Step S1211, the output control unit 115 sets “i” to “0” (S1213).

The output control unit 115 judges whether “i” is smaller than “N” (S1214). As described above, “N” is the number of records in the personal data table 131′.

When “i” is not smaller than “N” as a result of the judgment in Step S1214, the output control unit 115 increments “s” by 1 to “s+1” (S1215) and performs the processing in Step S1211 and the subsequent steps.

When “i” is smaller than “N” as a result of the judgment in Step S1214, the output control unit 115 judges whether “B[i]” is “0” and a safe item value set stored in an “s”th record in the “j”th analysis result data table 134-a is included in the “i”th record in the personal data table 131′ (S1216).

Specifically, for example, when “i” is “0”, “j” is “1”, “s” is “0”, and “B[0]” is “0”, the output control unit 115 extracts a “0”th record in the personal data table 131′, the example of which is shown in FIG. 8, i.e., values “male”, “33”, and “215-0013” of the fields 801 to 803. Moreover, the output control unit 115 extracts, with reference to the first analysis result data table 134-a, i.e., the analysis result data table 134-a2, the example of which is shown in FIG. 5B-2, a “0”th record, i.e., values “sex”, “male”, “age”, and “33” of the fields 542 to 545. In this case, the value “male” of the field 801 of the “0”th record in the personal data table 131′, the example of which is shown in FIG. 8, and the value “male” of the field 543 of the “0”th record in the analysis result data table 134-a2, the example of which is shown in FIG. 5B-2, coincide with each other. The value “33” of the field 802 of the “0”th record in the personal data table 131′, the example of which is shown in FIG. 8, and the value “33” of the field 545 of the “0”th record in the analysis result data table 134-a2, the example of which is shown in FIG. 5B-2, coincide with each other. Therefore, the output control unit 115 judges that a safe item value set corresponding to the values is included in the “s”th record.

When the safe item value set stored in the “s” record in the “j”th analysis result data table 134-a is not included in the “i”th record in the personal data table 131′ as a result of the judgment in Step S1216, the output control unit 115 increments “i” by 1 to “i+1” (S1217) and performs the processing in Step S1214 and the subsequent steps again.

When the safe item value set stored in the “s”th record in the “j”th analysis result data table 134-a is included in the “i”th record in the personal data table 131′ as a result of the judgment in Step S1216, the output control unit 115 updates an array “E[ ] [ ]” and an array “B[ ]” (S1218). For example, item values coinciding with one another among the item values of the items indicated by the integer “v” are included in both the “i”th record in the personal data table 131′ and the “s”th record in the “j”th analysis result data table 134-a. In this case, the output control unit 115 sets “E[i] [v]” to “1”. Moreover, the output control unit 115 extracts, from the “s”th record in the “j”th anlysis result data table 134-a, the number “nr” of records, which are an item and an item value of the record, and sets “B[i]” to “nr”.

Specifically, for example, when “i” is “0”, “j” is “1”, and “s” is “0”, as described above, as described above, the value “male” of the field 801 of the “0”th record in the personal data table 131′, the example of which is shown in FIG. 8, and the value “male” of the field 543 of the “0”th record in the analysis result data table 134-a2, the example of which is shown in FIG. 5B-2, coincide with each other. The value “33” of the field 802 of the “0”th record in the personal data table 131′, the example of which is shown in FIG. 8, and the value “33” of the field 545 of the “0”th record in the analysis result data table 134-a2, the example of which is shown in FIG. 5B-2, coincide with each other. As described above, the integer indicating the item “sex” is “0” and the integer indicating the item “age” is “1”. In this case, the output control unit 115 sets “E[0] [0] ” to “1” and sets “E[0] [1] ” to “1”. Then umber of records “nr” of the “0”th record in the analysis result data table 134-a2, the example of which is shown in FIG. 5B, is the value “2400” of the field 541. Therefore, the output control unit 115 sets “B[0]” to “2400”.

The output control unit 115 performs the processing in Step S1210 and the subsequent steps again.

On the other hand, when “j” is not equal to or larger than “0” as a result of the judgment in Step S1209, the output control unit 115 sets “i” to “0” (S1219).

The output control unit 115 judges whether “i” is smaller than “0” (S1220).

When “i” is smaller than “0” as a result of the judgment in Step S1220, the output control unit 115 stores values of A[i] and B[i] as values of the frequency of same value before anonymization 601 and the frequency of same value after anonymization 602 of the “i”th record in the output data 121, respectively (S1221). Moreover, the output control unit 115 adds, with reference to the output judgment table (the array “E [u] [v]”), item values corresponding to the safe item value set among the item values of the “i”th record in the personal data table 131′ to the output data 121 (S1222). Therefore, the output control unit 115 judges whether “E[i][x]” is “1”. It is to be noted that “x” is an integer that takes a value of “0, 1, . . . , (M−1)”. As described above, “M” is the number of items in the personal data table 131′. When “E[i] [x]” is “1”, the output control unit 115 extracts a value of “D[i] [x]” from the personal data table 131′ and stores the extracted value of “D[i] [x]” as an item value of an “x”th item among items 913 to 915 of the “i”th record in the output data 121. When “E[i] [x]” is “0”, the output control unit 115 stores a null value as the item value of the “x”th item among the items 913 to 915 of the “i”th record in the output data 121. The output control unit 115 applies this processing to the values 0, 1, . . . , (M−1) of x.

Specifically, for example, when “i” is “0”, “x” is “0”, and “E[0] [0]” is “1”, the output control unit 115 extracts a value of “D[0] [0]”=male” from the personal data table 131′, the example of which is shown in FIG. 8, and stores the extracted value of “D[0][0]=male” as an item value of a “0”th item among the items 913 to 915 of the “0”th record in the output data 121, i.e., an item value of the item 913 “sex”.

The output control unit 115 increments “i” by 1 to “i+1” (S1223).

On the other hand, when “i” is not smaller than “0” as a result of the judgment in Step S1220, the output control unit 115 outputs the output data 121 to other apparatuses (now shown) and the like through the output device 105 and the communication device 106 (S1224)

An example of a screen outputted in Step S1224 is the same as that shown in FIG. 9.

### Second Embodiment

A second embodiment of the present invention is explained.

The second embodiment is different from the first embodiment only in processing for interactively anonymizing and outputting data. In explaining the second embodiment below, components same as those in the first embodiment are denoted by the same reference numerals and signs and explanation of the components is omitted. Operations same as those in the first embodiment are briefly explained.

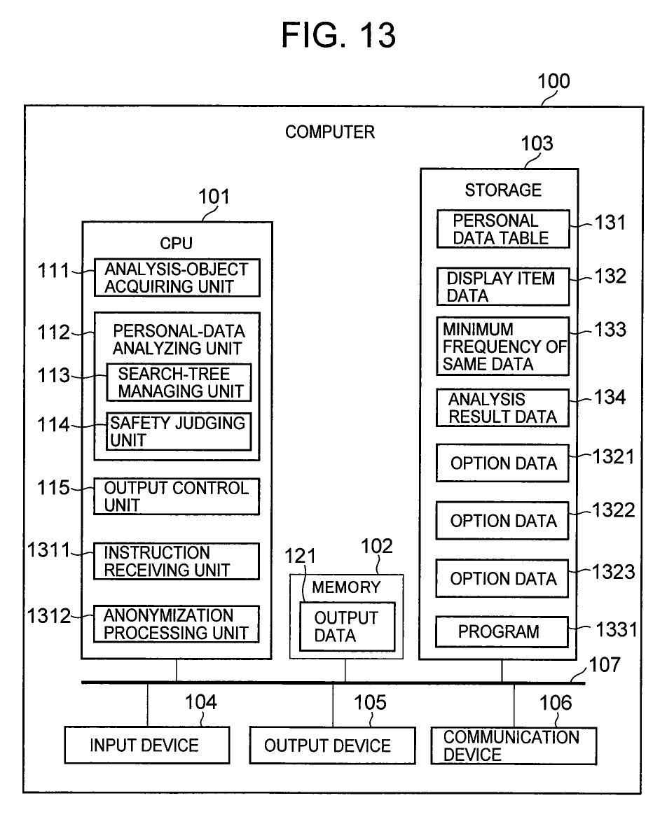

An example of the structure of the computer 100 according to the second embodiment is explained with reference to FIG. 13.

In FIG. 13, the storage 103 of the computer 100 has a program 1331 instead of the program 141. The storage 103 further has option data 1321 to 1323.

The respective option data 1321 to 1323 have options for anonymization, i.e., an item “sex”, an item “age”, and an item “zip code”. Details of the option data 1321 to 1323 are described later.

The CPU 101 executes the program 1331 loaded to the memory 102 to thereby further realize an instruction receiving unit 1311 and an anonymization processing unit 1312. The instruction receiving unit 1311 receives an input of anonymization conditions for each item to be outputted. The anonymization processing unit 1312 processes, according to the inputted anonymization conditions, data to be outputted.

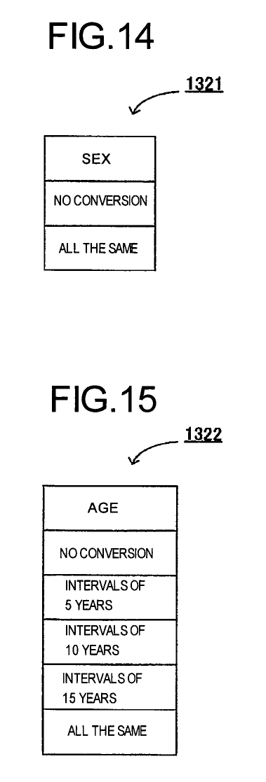

Examples of the option data 1321 to 1323 are explained with reference to FIGS. 14 to 16.

First, an example of the option data 1321 is explained with reference to FIG. 14.

In FIG. 14, the option data 1321 includes two or more options for anonymizing the item “sex”. In the example in FIG. 14, the option data 1321 includes “no conversion” and “all the same” as options. The option “no conversion” indicates that item values “male” and “female” of the item “sex” of the respective records in the personal data table 131 are directly used. The option “all the same” indicates that all item values are converted into a value representing “unclear” in the item “sex” of the respective records in the personal data table 131.

Next, an example of the option data 1322 is explained with reference to FIG. 15.

In FIG. 15, the option data 1322 includes two or more options for anonymizing the item “age”. In the example in FIG. 15, the option data 1322 includes “no conversion”, “at intervals of 5 years”, “at intervals of 10 years”, “at intervals of 15 years”, and “all the same” as options. The option “no conversion” indicates that item values of the item “age” of the respective records in the personal data table 131 are directly used. The option “at intervals of 5 years” indicates that the ages of every 5 years old are used as one item value in the item “age” of the respective records in the personal data table 131. Specifically, for example, the ages of 21 to 25 years old are used as one item value. The option “at intervals of 10 years” indicates that the ages of every 10 years old are used as one item value in the item “age” of the respective records in the personal data table 131. The option “at intervals of 15 years” indicates that the ages of every 15 years are used as one item value in the item “age” of the respective records in the personal data table 131. The option “all the same” indicates that all item values are converted into a value representing “unclear” in the item “age” of the respective records in the personal data table 131.

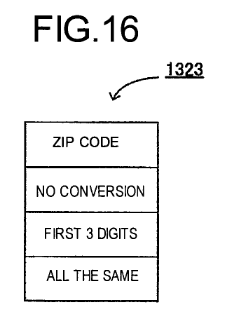

Next, an example of the option data 1323 is explained with reference to FIG. 16.

In FIG. 16, the option data 1323 includes two or more options for anonymizing the item “zip code”. In the example in FIG. 16, the option data 1323 includes “no conversion”, “first 3 digits”, and “all the same” as options. The option “no conversion” indicates that item values of the item “zip code” of the respective records in the personal data table 131 are directly used. The option “first 3 digits” indicates that item values having the same first three digits are used as one item value in the item “zip code” of the respective records in the personal data table 131. Specifically, for example, a zip code “215-0013” and a zip code “215-0016” are used as one item value. The option “all the same” indicates that all item values are converted into a value representing “unclear” in the item “zip code” of the respective records in the personal data table 131.

Anonymization options for the item “sex”, the item “age”, and the item “zip code” are arbitrary and are not limited to the above.

In this embodiment, since items to be displayed are “sex”, “age”, and “zip code”, options for these items are set, respectively. However, as described above, the items to be displayed are not limited to “sex”, “age”, “zip code”, and the like. In other words, the anonymization options may be set according to the items to be displayed.

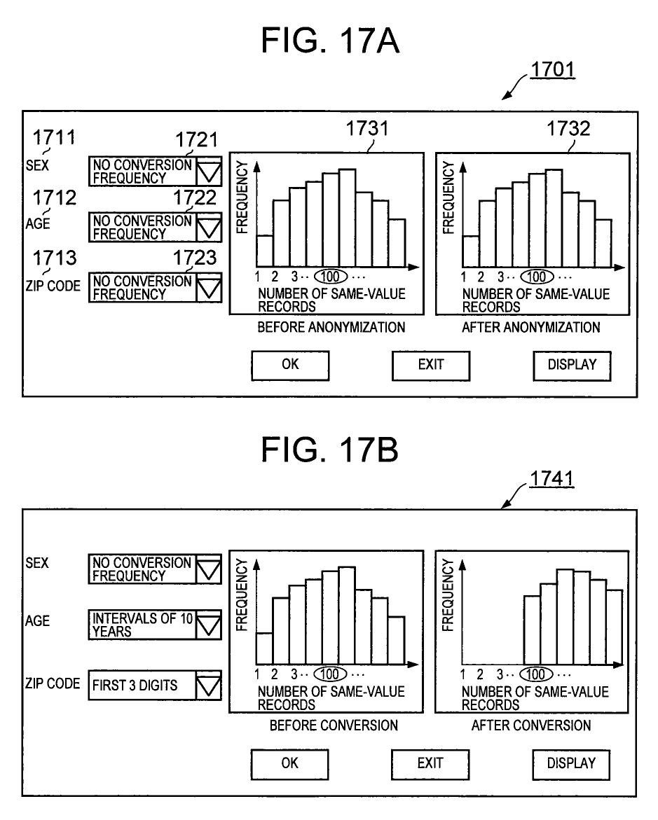

Before explaining an example of an operation, examples of a screen that the computer 100 displays on the display of the output device 105 or the like in the second embodiment are explained with reference to FIGS. 17A and 17B.

As described above, the computer 100 according to the second embodiment performs the processing for interactively anonymizing and outputting data. Examples of a screen for interactively anonymizing data are shown in FIGS. 17A and 17B. In FIG. 17A, a screen 1701 includes pull-down menus 2721 to 1723, and the like. Each of these pull-down menus is a pull-down menu for selecting an anonymization option for each of items 1711 to 1713. The items 1711 to 1713 are the same as the items included in the display item data 132. A user selects anonymization options in the respective pull-down menus 1721 to 1723 using the input device 104 and the like.

The screen 1701 includes sub-screens 1731, 1732, and the like. On the sub-screen 1731, a histogram indicating a distribution of the number of same-value records before the selection of anonymization options for the respective items in the pull-down menus 1721, 1722, 1723, and the like is displayed. On the sub-screen 1732, a histogram indicating a distribution of the number of same-value records at the time of the selection of an anonymization option in at least one of the pull-down menus 1721, 1722, 1723, and the like is displayed. In the histograms displayed on the sub-screens 1731 and 1732, the abscissa indicates the number of same-value records and the ordinate indicates the frequency of same-value records. As described above, the number of same-value records indicates the number of items having the same set of item values of items in the minimum frequency of same data 133 among items of personal data. The frequency of same-value records is the number of combinations that have the same number of same-value records even if combinations of item values of items in the minimum frequency of same data 133 among the items of the personal data are different. Specifically, for example, in the case of the output data 121, the example of which is shown in FIG. 6, the number of same-value records of a record in which item values of the item 913 “sex”, the item 914 “age”, and the item 915 “zip code” are “male”, “33”, and “−”, respectively, is the item value “50” of the item 911 “frequency of same value before anonymization” of the same record. The number of same-value records of a record in which item values of the item 913“sex”, the item 914 “age”, and the item 915 “zipcode” are “female”, “25”, and “−”, respectively, is the item value “50” of the item 911 “frequency of same value before anonymization” of the same record. The item value of the item 911 “frequency of same value before anonymization” is a value of the number of same-value records on the abscissa of the histogram displayed on each of the sub-screens 1731 and 1732. The number of records in which item values of the item 911 “frequency of same value before anonymization” is the same “50” is a value of the number of same-value records on the ordinate of the histogram displayed on each of the sub-screens 1731 and 1732.

On the abscissa of the histogram displayed on each of the sub-screens 1731 and 1732, a display form of a value of a threshold as a judgment reference for anonymization may be changed. This threshold is the minimum frequency of same value 401 stored in the minimum frequency of same data 133. This display form may be changed arbitrarily. For example, colors of numerical values may be changed or a color of the histogram may be changed with the threshold as a boundary. In the example in FIG. 17, a threshold “100” is encircled.

The screen 1701 in FIG. 17A is an example of a screen in which anonymization options for the respective items are not selected in the pull-down menus 1721, 1722, 1723, and the like. Therefore, a histogram same as that on the sub-screen 1731 is displayed on the sub-screen 1732.

The screen 1741 in FIG. 17B is an example of the screen 1701 in which anonymization options for the respective items are selected in the pull-down menus 1721, 1722, 1723, and the like. In the case of the screen 1741 in FIG. 17B, an anonymization option is not selected in the pull-down menu 1721, “at intervals of 10 years” is selected in the pull-down menu 1722, and “first 3 digits” is selected in the pull-down menu 1723.

When the anonymization options for the respective items are selected in the pull-down menus 1721, 1722, 1723, and the like, in processing described later, the computer 100 performs the processing for display of the histogram displayed on the sub-screen 1732 again according to the selected options. Consequently, the histogram displayed on the sub-screen 1732 is changed. In the example in FIG. 17B, compared with FIG. 17A, the distribution of the histogram on the sub-screen 1732 shifts to the left.

The second embodiment is characterized in that the user can adjust an anonymization method using the interface described above such that a minimum value of the number of same-value records is satisfied.

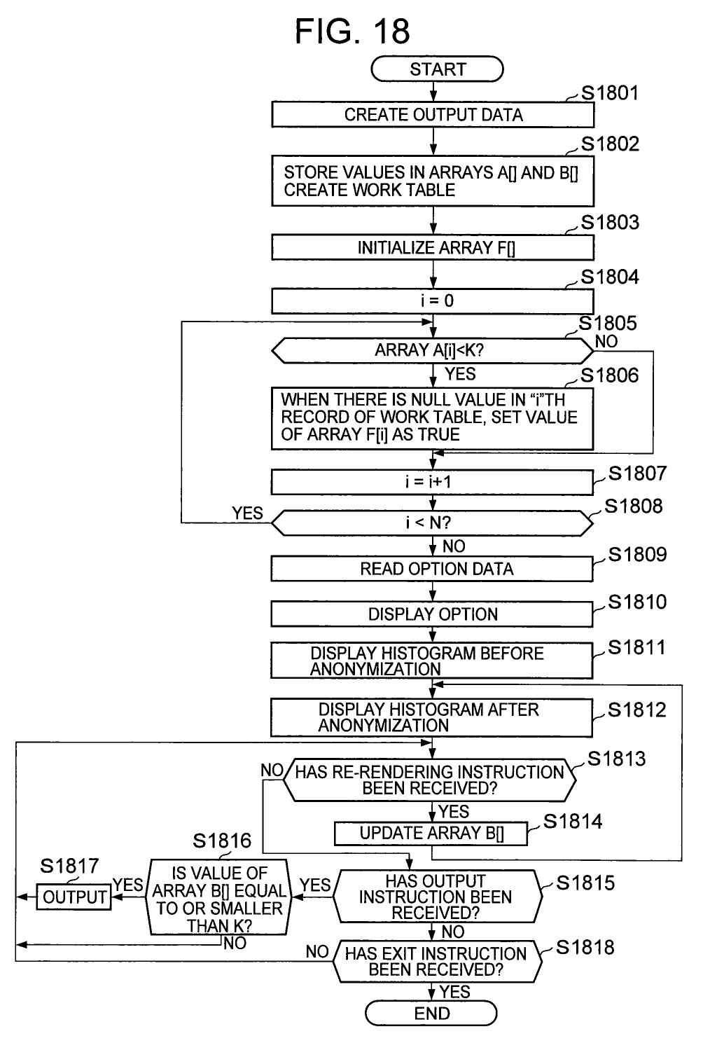

An example of an operation of the computer 100 according to the second embodiment is explained with reference to FIG. 18. The example of the operation according to the second embodiment is different from the example of the operation according to the first embodiment only in that the operation is once finished after Step S711 and, then, output processing described below is performed. Therefore, only this output processing is explained. The other processing is the same as the processing according to the first embodiment.

Timing for starting an operation described below is time when the user who judges that acquired data is insufficient instructs the selection of anonymization after the result, the example of which is shown in FIG. 9, is displayed. However, the timing for starting the operation may be arbitrary. For example, the timing may be arbitrary timing such as time when an instruction is inputted from the user or a predetermined time.

In FIG. 18, the output control unit 115 generates the output data 121 (S1801). This processing is the same as Steps S1201 to S1224. When the output data 121 is already generated, this processing does not have to be performed.

The anonymization processing unit 1312 stores values of the frequency of same value before anonymization and the frequency of same value after anonymization of the respective records in the output data 121 in an “array A[ ]” and an “array B[ ] ” used in processing described below. The anonymization processing unit 1312 reads record data including items designated in the display item data 132 into the memory 102 with reference to the output data 121 (S1802). Therefore, the anonymization processing unit 1312 stores, for example, a value of the frequency of same value before anonymization 601 of the respective records in the output data 121 in the “array A[ ]”. Moreover, the anonymization processing unit 1312 stores a value of the frequency of same value after anonymization 602 of the respective records in the output data 121 in the “array B[ ]”. A size of each of the “array A” and the “array B” is “N”. As described above, “N” is the number of records in the output data 121. The anonymization processing unit 1312 reads out item values of the items 603 to 605 of the respective records from the output data 121 and reads the item values into the memory 102. In the case of the output data 121, the example of which is shown in FIG. 6, the anonymization processing unit 1312 extracts item values of the item 603 “sex”, the item 604 “age”, the item 605 “zipcode” of the respective records from the output data 121 and stores the item values in the memory 102.

In the following explanation, when data stored in the memory 102 in the processing in Step S1802 is specifically distinguished, the data is referred to as “output data 121′”.

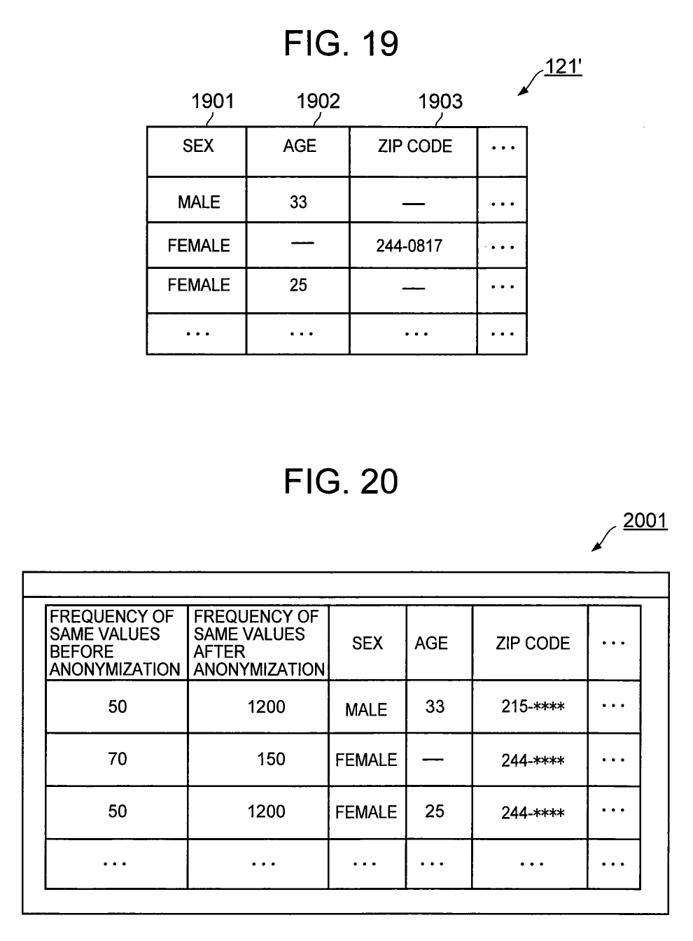

An example of the output data 121′ stored in the memory 102 in the processing in Step S1802 in the case of the output data 121, the example of which is shown in FIG. 6, is shown in FIG. 19. In FIG. 19, the output data 121′ has multiple records. The respective records have item values of items 1901 to 1903. Item values of the items 1901 to 1903 of the respective records are the same as the item values of the items 603 to 605 of the respective records in the output data 121.

In the following explanation, the items of the output data 121′ are referred to as anonymization object items. Respective elements of the output data 121′ are elements of a data type that can represent a null value. Specifically, for example, in the case of a structure of the C language, the elements include a variable region representing a data value and a Boolean variable region representing whether the data value variable region is a null value.

The anonymization processing unit 1312 initializes all elements of the “array F[ ]” (S1803). Therefore, the anonymization processing unit 1312 initializes all the elements of the “array F[ ]” to false values. A size of the “array F[ ]” is “M”. As described above, “M” is the number of items in the output data 121′.

When a j”th element of the “array F[ ]” is a false value, this indicates that anonymization of a jth anonymization object item in the output data 121′ is unnecessary. When the “j”th element is a true value, this indicates that anonymization of the jth anonymization object item is necessary.

The anonymization processing unit 1312 initializes a variable “i” indicating a record (S1804). Therefore, the anonymization processing unit 1312 sets “i” to “0”.

The anonymization processing unit 1312 judges whether “A[i]” is smaller than “K” (S1805). “A[i]” is an “i”th element of the “array A[ ]”. “K” is a value of the minimum frequency of same value “K” in the minimum frequency of same data 133. That is, in this processing, when the “i”th record in the output data 121′ is not anonymized, the anonymization processing unit 1312 judges whether an identification probability of the record is larger than “1/K”.

When “A[i]” is not smaller than “K” as a result of the judgment in Step S1805, the anonymization processing unit 1312 performs processing in Step S1807 and the subsequent steps described below.

When “A[i]” is smaller than “K” as a result of the judgment in Step S1805, the anonymization processing unit 1312 judges whether there is any item, a value of which is a null value, in the “i”th record in the output data 121′. As a result of the judgement, when there is an item, a value of which is a null value, the anonymization processing unit 1312 sets “F[j]” corresponding to an item “j”, a value of which is a null value, in the output data 121′ to a true value (S1806). Specifically, for example, when “i” is “0”, an item, a value of which is a null value, in the “i”th record in the output data 121′, the example of which is shown in FIG. 19, is the item 1903 “zip code”. In this embodiment, as described above, since the item “zipcode” is indicated by the number “2”, “j” is “2”. Therefore, the anonymization processing unit 1312 sets “F[2]” to a true value.

The anonymization processing unit 1312 increments “i” by 1 to “i+1” (S1807).

The anonymization processing unit 1312 judges whether “i” is smaller than N (S1808). As described above, “N” is the number of records in the output data 121.

When “i” is not smaller than “N” as a result of the judgment in Step S1808, the anonymization processing unit 1312 performs the processing in Step S1805 and the subsequent steps again.

When “i” is smaller than “N” as a result of the judgment in Step S1808, the anonymization processing unit 1312 reads out the option data 1321, 1322, 1323, and the like from the storage 103 and stores the option data in the memory 102 (S1809).

The instruction receiving unit 1311 displays anonymization options for the respective items (S1810). Therefore, for example, first, the instruction receiving unit 1311 refers to all the elements of the “array F [ ]” and specifies items of elements having true values among the elements. The instruction receiving unit 1311 selects display item data including optimization options for the specified items among the display item data 1321 to 1323. The instruction receiving unit 1311 generates data for displaying the specified items and the selected anonymization options and outputs the data to the display or the like of the output device 105.

Specifically, for example, “F[0]”, “F[1]”, and “F[2]” are included as all the elements of the “array F[ ]”. As described above, when the item number of the number “zero” indicates “sex”, the item number of the number “1” indicates “age”, and the item number of the number “2” indicates “zip code”, the instruction receiving unit 1311 sets the item “sex”, the item “age”, and the item “zip code” as items having true values. The instruction receiving unit 1311 reads out the option data 1321 including anonymization options for the item “sex”, the option data 1322 including anonymization options for the item “age”, and the option data 1323 including anonymization options for the item “zip code” from the storage 103 and stores the option data in the memory 103. The instruction receiving unit 1311 generates, for example, using a predetermined format, data for displaying the item “sex”, the item “age”, and the item “zip code” and the anonymization options stored in the option data 1321 to 1323. The instruction receiving unit 1311 displays the anonymization options stored in the option data 1321 to 1323, for example, as pull-down menus. According to the processing, the items 1711 to 1713 and the pull-down menus 1721 to 1723 shown in FIG. 17 are displayed.

The instruction receiving unit 1311 displays a histogram before the selection of anonymization options (S1811). Therefore, the instruction receiving unit 1311 adds up the values of the “array A[ ]” and acquires the number of same-value records and the frequency of same-value records. The instruction receiving unit 1311 generates a histogram with the acquired number of same-value records plotted on the abscissa and the acquired frequency of same-value records plotted on the ordinate and outputs the histogram to the display or the like of the output device 105. According to this processing, the sub-screen 1731 shown in FIG. 17 is displayed.

The instruction receiving unit 1311 displays a histogram after the selection of anonymization options (S1812). Therefore, the instruction receiving unit 1311 adds up the values of the “array B [ ]” and acquires the number of same-value records and the frequency of same-value records. The instruction receiving unit 1311 generates a histogram with the acquired number of same-value records plotted on the abscissa and the acquired frequency of same-value records plotted on the ordinate and outputs the histogram to the display or the like of the output device 105. According to this processing, the sub-screen 1732 shown in FIG. 17 is displayed.

When anonymization options are not inputted from the input device 104 or the like in the processing in Step S1812, the instruction receiving unit 1311 displays the histogram before the selection of anonymization options instead of the histogram after the selection of anonymization options. An example of this operation for displaying the histogram before the selection of anonymization options is the same as the operation in Step S1811. Processing for judging whether anonymization options are inputted may be arbitrary. For example, the judgment may be performed by referring to a flag that is changed when at lest one of the pull-down menus 1721 to 1723, the example of which is shown in FIG. 17, is operated.

The instruction receiving unit 1311 judges whether re-rendering is instructed (S1813). This judgment on re-rendering instruction may be arbitrary. For example, the judgment may be performed according to whether a “OK” button on the screen, the example of which is shown in FIG. 17, is depressed.

When the re-rendering is instructed as a result of the judgment in Step S1813, the anonymization processing unit 1312 updates the value stored in the array “B[ ]” in accordance with conditions decided by anonymization options received together with the instruction for re-rendering (S1814). Therefore, for example, the anonymization processing unit 1312 refers to the personal data table 131, counts, for each item, the number of same-value records of the respective records in accordance with the conditions decided by the anonymization options received together with the instruction for re-rendering, and stores a value of the count in the “array B[ ]”. Processing itself by the anonymization processing unit 1312 for counting the number of same-value records is the same as the processing described above except that the number of same-value records is counted in accordance with the conditions decided by the anonymization options received together with the instruction for re-rendering. Specifically, for example, when an anonymization option “at intervals of 10 years” is designated in the pull-down menu 1722, the example of which is shown in FIG. 17, the anonymization processing unit 1312 counts item values of the item 203 “age” in the personal data table 131 as the same item value if the item values are in a range of “21 to 30”. In the counting, the anonymization processing unit 1312 performs, with respect to the personal data table 131, same-value judgment on only item values that are null values in the output data 121 in accordance with the anonymization options. The anonymization processing unit 1312 performs same-value judgment on item values that are not null values in the output data 121 without using the anonymization options.

After the processing in Step S1814, the instruction receiving unit 1311 performs the processing in Step S1812 and the subsequent steps again.

On the other hand, when re-rendering is not instructed as a result of the judgment in Step S1813, the instruction receiving unit 1311 judges whether output is instructed (S1815). This judgment on the instruction of output may be arbitrary. For example, the judgment may be performed according to whether a “display” button on the screen, the example of which is shown in FIG. 17, is depressed.

When output is instructed as a result of the judgment in Step S1815, the instruction receiving unit 1311 judges whether each of the values stored in the “array B[ ]” is equal to or smaller than “K” (S1816). As described above, “K” is a value of the minimum frequency of same value 401 included in the minimum frequency of same data 133.

When at least one of the values stored in the array “B[ ]” is not equal to or smaller than “K” as a result of the judgment in Step S1815, the instruction receiving unit 1311 performs processing in Step S1812 and the subsequent steps again. The instruction receiving unit 1311 may output, to the output device 105, the communication device 106, or the like, data for requesting that anonymization options for the respective items should be designated to set a minimum value of the number of same-value records to be equal to or smaller than “K”.

When all the values stored in the “array B[ ]” are equal to or smaller than “K” as a result of the judgment in Step S1816, as in Step S1814, the output control unit 15 performs same value judgment with respect to the personal data table 131, converts the personal data table 131′ in accordance with conditions decided by anonymization options for the respective items received together with the instruction for re-rendering, updates the output data 121 in accordance with the converted data, and outputs the output data 121 to the output device 105, the communication device 106, or the like (S1817). Therefore, first, the output control unit 115 stores the respective values of the “array B [ ]” as values of the frequency of same value after anonymization 602 of the respective records in the output data 121. Moreover, the output control unit 115 converts the respective item values of the respective records in the personal data table 131′ in accordance with conditions decided by anonymization options for the respective items received together with the instruction for re-rendering and stores the respective converted item values as the items 603 to 605 of the respective records in the output data 121. The output control unit 115 outputs the updated output data 121 to the output device 105, the communication device 106, or the like.

Specifically, for example, the anonymization option “at intervals of 10 years” is designated in the pull-down menu 1722, the example of which is shown in FIG. 17, and the anonymization option “first 3 digits” is designated in the pull-down menu 1723. In this case, the output control unit 115 stores the respective values of the “array B[ ]” as values of the frequency of same value after anonymization 602 of the respective records in the output data 121. The output control unit 115 converts the item values of the items “age” and “zip code” for which anonymization options are designated from the items 801 to 803 of the personal data table 131′, in accordance with conditions decided by the designated options. The output control unit 115 converts an item value of the item 802 of the respective records in the personal data table 131′ into a value of “at intervals of 10 years”. Specifically, for example, when the item value of the item 802 in the personal data table 131′ is “33”, the output control unit 115 converts the item value into “31 to 40”. The output control unit 115 converts an item value of the item 803 of the respective records in the personal data table 131′ into a value of “first 3 digits”. Specifically, for example, when the item value of the item 803 in the personal data table 131′ is “215-0013”, the output control unit 115 converts the item value into “215-****”. The output control unit 115 stores each of the converted item values of the respective records as each of the items 604 and 605 of the respective records in the output data 121.

An example of a screen for displaying, on the display or the like of the output device 105, the output data 121 updated when the anonymization option “at intervals of 10 years” is designated in the pull-down menu 1722, the example of which is shown in FIG. 17, and the anonymization option “first 3 digits” is designated in the pull-down menu 1723 is explained with reference to FIG. 20.

In FIG. 20, a screen 2001 is an example of a screen displayed when an anonymization option of the item “age” is “at intervals of 10 years” and an anonymization option of the item “zip code” is “first 3 digits. As shown in screen 2001 as an example, item values of the items “age” and “zip code” among item values of respective data entities are displayed to include multiple different item values such as “at intervals of 10 years” and “first 3 digits”. In this way, rather than not displaying item values having identification probabilities equal to or higher than the threshold at all, multiple item values are displayed as one item value. Consequently, it is possible to provide data while keeping a level of an identification probability.

In FIG. 18, after the processing in Step S1817, the instruction receiving unit 1311 performs the processing in Step S1812 and the subsequent steps again.

On the other hand, when output is not instructed as a result of the judgment in Step S1815, the instruction receiving unit 1311 judges whether an instruction of exit has been received (S1818). This judgment on the exit instruction may be arbitrary. For example, the judgment may be performed according to whether a “exit” button on the screen, the example of which is shown in FIG. 17, is depressed.

When the exit instruction has been received as a result of the judgment in Step S1818, the instruction receiving unit 1311 finishes the processing.

When the exit instruction has not been received as a result of the judgment in Step S1818, the instruction receiving unit 1311 returns to the processing in Step S1813.

In the processing described above, when all the items in the array “F[j]” are set to true values in Step S1806, even if the processing leaves a loop formed by Steps S1805 to S1808, results obtained in Step S1809 and the subsequent steps are the same.

In this way, in the second embodiment, it is possible to distinguish items required to be anonymized and display the items, execute anonymization only for an item value set with the small number of same-value records, and compare a result of anonymization with items before anonymization and judge the result.

The embodiments of the present invention have been explained in detail with reference to the drawings. However, a specific configuration is not limited to the embodiments and includes a design change and the like without departing from the spirit of the present invention.

For example, in the second embodiment, anonymization options are selected until the number of same-value records decreases to be equal to or smaller than the minimum frequency of same value “K”. However, the present invention is not limited to this. Item values having the number of same-value records equal to or smaller than the minimum frequency of same value “K” only have to be not displayed. Therefore, for example, unlike the first embodiment, item values having the number of same-value records equal to or smaller than the minimum frequency of same value “K” do not have to be displayed. In that case, it is advisable that, for example, the output control unit 115 does not update records corresponding to values stored in the “array B[i]” equal to or smaller than “K” among the respective records in the output data 121 are not updated as described above and values corresponding to values not stored in the “array B[i]” equal to or smaller than “K” are updated as described above.

What is claimed is:

1. A information output apparatus, comprising:
a storing unit which stores multiple personal data including multiple items;
a count unit which selects at least one of the multiple items for each of the multiple personal data and counts the number of personal data that include the same item values as an item value of the selected item;
a judging unit which judges whether the number of personal data is at least equal to a threshold; and
a result output unit which outputs, when it is judged that the number of personal data is at least equal to the threshold, only the item value of the selected item to a output device.

2. A information output apparatus according to claim 1, further comprising:
a condition output unit which further outputs, for each of the multiple items, multiple conditions covering different item values, to the output device, wherein:
the count unit selects at least one of the multiple items for each of the multiple personal data, and counts, in accordance with an inputted condition among the outputted conditions, the number of personal data that include a combination of item values to be treated as the same item values as the item value of the selected item; and
the result output unit outputs, when the number of personal data is at least equal to the threshold, an item value of the selected item, to the output device under the inputted condition.

3. A information output apparatus according to claim 2, further comprising:
a frequency-distribution output unit which acquires personal data including a combination of the same item values and frequency of respective personal data that include a combination of item values to be treated as the same item values, and further outputs a frequency distribution of the acquired frequencies to the output device.

4. A information output apparatus according to claim 3, wherein the frequency-distribution output unit outputs, to the output device, both a frequency distribution of frequencies of personal data that include a combination of the same item values before conforming to an inputted condition among the outputted conditions, and a frequency distribution of frequencies of personal data conforming to the inputted condition among the outputted conditions and including the combination of the item values to be treated as the same item values.

5. A information output apparatus according to claim 1, wherein:
the count unit selects one of the multiple items and counts the number of personal data having the same item values as an item value of the selected item;
the judging unit judges whether the number of personal data is at least equal to the threshold every time the number of personal data is counted by the count unit; and
the count unit selects, when the judging unit judges that the numbers of personal data is at least equal to the threshold, a combination of different items while increasing one item of the multiple items at a time, counts, every time an item is selected, the number of personal data having the same item values as an item value of the selected item, stops the selection of an item and the count of the number of personal data when the judging unit judges that the number of personal data is not at least equal to the threshold, and causes the output device to output an item value of an item selected immediately before the stopping.

6. A information output method which outputs personal data to a output device, the data output method comprising:
a storing step of storing multiple personal data including multiple items;
a counting step of selecting at least one of the multiple items for each of the multiple personal data and counting the number of personal data that include the same item values as an item value of the selected item;
a judging step of judging whether the number of personal data is at least equal to a threshold; and
a result outputting step of outputting, when it is judged that the number of personal data is at least equal to the threshold, only the item value of the selected item, to output device.

7. A information output program product which is executable on a information output apparatus and which outputs personal data to a output device, the program being configured to execute:
a storing step of storing multiple personal data that include an item value of each of multiple items;
a counting step of selecting at least one of the multiple items for each of the multiple personal data and counting the number of personal data that include the same item values as an item value of the selected item;
a judging step of judging whether the number of personal data is at least equal to a threshold; and
a result outputting step of outputting, when it is judged that the number of personal data is at least equal to the threshold, only the item value of the selected item, to the output device.
